(19) United States
(12) Patent Application Publication
(10) Pub. No.: US 2012/0057740 A1
(43) Pub. Date: Mar. 8, 2012

(54) Security and protection device for an ear-mounted audio amplifier or telecommunication instrument

(76) Inventor: Mark Bryan Rosal, Winfield (CA)

(21) Appl. No.: 13/373,394

(22) Filed: Nov. 14, 2011

Related U.S. Application Data
(63) Continuation-in-part of application No. 11/376,637, filed on Mar. 15, 2006, now abandoned.

(51) Int. Cl. H04R 1/10

(52) U.S. Cl. 381/380

(57) ABSTRACT

A security and protection device for an ear-mounted audio amplifier or telecommunication instrument. The device includes a resilient water-pervious hollow sleeve sized and shaped to snugly conform to the shape of an audio amplifier or telecommunication instrument having an earpiece insertable in to the ear of a user when the sleeve is slid over the instrument. The sleeve has a top opening at a top end of the sleeve and a bottom opening at an opposite bottom end of the sleeve. The bottom opening is sized to snugly receive the instrument into the hollow sleeve so as to substantially completely cover the instrument when journalled in the sleeve. The top opening is sized to snugly receive through the top opening a corresponding upper end of the instrument. The upper end of the instrument is connected to the instrument earpiece.

### CROSS REFERENCE TO RELATED APPLICATION

This application is a continuation-in-part of U.S. patent application Ser. No. 11/376,637 filed Mar. 15, 2006 entitled Ear Gear.

### FIELD OF THE INVENTION

This invention relates to the field of devices for securing ear-mounted audio amplifiers such as hearing aids and ear-mounted telecommunication instruments such as wireless headsets for cellular telephones to the body or clothing of the user, and in particular to a soft resilient sleeve having apertures positioned to accommodate the insertion and removal of the various instruments.

### BACKGROUND OF THE INVENTION

Ear-mounted audio amplifiers such as hearing aids and ear-mounted telecommunication instruments such as Bluetooth™ wireless headsets for cellular phones are hard objects about the size of a thumb that fit Behind the Ear (BTE) or In the Ear (ITE). They come in various lengths and widths. Wireless headsets such as referred to as Bluetooth™ headsets, referring to the wireless communication format or protocol employed, communicate with correspondingly equipped cellular telephones, and other telecommunication devices such as mounted in vehicles. These wireless headsets are worn by, for example, the vehicles' drivers to provide hands-free use, and include an earpiece which, like a hearing aid earmold, is inserted into the user's ear. The earpiece is mounted to the device body.

With respect to hearing aids, there are also Cochlear models that are surgically inserted behind the ear. A processor that resembles the BTE Hearing Aids mounts externally onto the inserted portion. Hearing Aid Instruments are made of plastic and are designed to improve the hearing of the person wearing them. ITE, BTE and BTE Cochlear hearing aids are worn by young children, adults and elderly people with a range of special needs.

Some young children who are hard of hearing also have other developmental delays while some elderly individuals may have dementia, or simply may be forgetful. Both young children and elderly people with impaired mental functioning will from time to time take off their BTE, ITE or BTE Cochlear hearing aids and discard them, or not put them in a safe place.

The hearing aid instruments can squeal and cause irritation, perspiration and chaffing for the person wearing them. This is a problem as the wearer can develop sores behind their ear or in their ear. Additionally, when Hearing Aid Instruments are exposed to moisture the batteries in the hearing aids burn out more quickly. Hearing Aids can fall off when a person is running or involved in a sporting activity such as tennis or soccer.

Applicant is aware of three security devices on the market for Hearing Aid Instruments, and two other devices that attempt to reduce the amount of moisture that Hearing Aid Batteries are exposed to.

One such security device was developed by PHONAK™ and is called Kids Clip. It has a small plastic ring that surrounds a BTE Hearing aid. A pair of the plastic rings are attached to a long (16″) cord that meet at the centre attaching to a clip. The clip then attaches to clothing. To applicant's knowledge, the PHONAK™ plastic ring breaks with little wear and tear and can easily be chewed by a small child that would put the device in their mouth.

The second security device of which applicant is aware is called a Huggie Catchar™. It has a larger main plastic ring that goes around the ear. The main plastic ring has two smaller plastic rings that go around the BTE at the top and bottom of the BTE. This device also has a plastic cord that attaches to a clip used to secure the device to clothing. This devise is cumbersome and makes a Hearing Aid even more uncomfortable on small ears.

The third security device is called an Oto clip™. It includes a piece of string having a plastic loop at each end. A clip at the centre attaches to clothing. This device is difficult to place on a BTE and does not provide adequate security since the loop can slip open or the plastic piece can break off.

There are also two devices that attempt to protect hearing aids from moisture. These are called the Hearing Aid Sweatband and Super Seals.

The Hearing Aid Sweat Band is made from fabric that is both moisture repellent and moisture absorbent, the fabric does not inhibit sound. It is disposable and has limited wear.

Super Seals are flexible latex covers made for protecting a hearing aid from moisture. They protect the amplifier, case, controls and battery compartment of a hearing aid, while leaving an opening for sound to enter the microphone. While Super Seals may protect hearing aid Instruments from moisture they do not reduce chafing. In addition, they do not provide security. Super Seals do not let moisture in but conversely they also trap moisture.

Hearing Aid Sweat Band and Super Seals may protect Hearing Instruments batteries from perspiration, moisture, dirt and grime, but they do not protect the wearer's ear from chaffing and do not protect against loss of the hearing aid.

In the prior art, I am aware of U.S. Pat. No. 5,249,234 which issued to Butler Sep. 28, 1993, for a Cover for Behind-the-Ear Type Hearing Aids and Methods of Making and Using Same.

### SUMMARY OF THE INVENTION

The Protective device according to the present invention is a hearing aid security and protection device that protects hearing aid instruments from loss, moisture, wind and dirt while making them more comfortable for the user of the hearing aid to wear. The Protective device is made from Spandex or other soft resilient materials. It includes a sleeve and cord, in a variety of lengths and widths to fit different types of hearing aids; including BTE, ITE, Mini, Cochlear, and FM wearing aids, (herein referred to in short form as BTEs, ITEs, Minis, Cochlears and FMs respectively and collectively as Protective devices).

The protective devices have sleeves having a small opening at the top end of the sleeve and a large opening at the bottom end. A left sleeve and a right sleeve are attached to the opposite ends of a length of stretch cord. The center of the length of cord is connected to a clip, which releasably attaches the cord to clothing. To install the Protective device on a hearing aid, the hearing aid earmold is removed from the hearing aid; and the top end of the hearing aid slid upwardly through the opening bottom in the end of the Protective device sleeve until the hearing aid is fully encased within the sleeve within the top of the hearing aid flush with the top end of the sleeve. The earmold is then reattached to the hearing aid.

The sleeve is sized to fit securely and snuggly around the hearing aid instrument. The sleeve maybe made of soft stretch fabric and advantageously repels external moisture and/or absorbs moisture forming internally within the sleeve, or perspiration from the wearer without appreciably attenuating sound. An independent test of a Spandex™ fabric sleeve has shown a loss of volume of 1 db. In one embodiment the sleeve is one and ¾ inches long and fits most BTEs. The sleeve for FMs is approximately two and ¾ inches long and fits a BTE with a FM attachment. Both sleeves have an approximately ¼ inch opening at the top end of the sleeve and a slightly wider approximately ⅝ inch opening at the bottom end of the sleeve. The middle of the sleeve is approximately ¾ inch across when laid flat. The BTE is held firmly in place on the hearing aid by the stretch fabric of the sleeve and because the smaller opening in the sleeve is only as large as the top end of the hearing aid where it attaches to the earmold. This inhibits the sleeve from slipping off and securely attaches the sleeve to the hearing aid. To remove the sleeve from the hearing aid a user has to slip the sleeve off deliberately. The stretch cord between the left and right sleeves, ie between a pair of hearing aids when mounted in the sleeves, may be approximately 16 inches for adult users, and approximately 12 inches long for infant and children users. The clip may be fastened mid way along the length of the cord. One advantage of having the pair of sleeves attached to the ends of the cord is that when the hearing aids fall off the user's ears, the hearing aids are somewhat protected encased within their sleeves, hanging down around the user's torso.

The protective devices protect hearing aid instruments from shutting off because of moisture from perspiration, rain or snow, and stops dust and dirt infiltration. The sleeve is sufficiently light weight and flexible so that hearing aid controls can be easily operated through the sleeve when in place on the hearing aid. The protective sleeve simply slips over the hearing aid and there is no need for an application procedure or special tool as in the Butler prior art referred to above. The fabric of the sleeve reduces chaffing around the top of the user's ear. When the user perspires, for example during exercise, the fabric of the sleeve will absorb the moisture and thereby reduce chaffing.

The sleeve may be constructed using fabrics which resiliently stretch and are both moisture repelling on the outside and moisture absorbing on the inside of the sleeve. Such fabrics may include neoprene, Spandex, elasticized wool or elasticized cotton. The sleeve may be knitted or otherwise constructed so that the cord and the sleeve may be made as one integral unit. In one embodiment the cord is sewn to the sleeves. That attachment may be reinforced with rubber glue.

There are several variations that can be made to the sleeve. One variation is the length of the sleeve. It can be shorter or longer to accommodate a range of BTEs or ITEs. For use with BTEs the sleeve may be open at the back, so that users can access controls more easily. This open back can also include a flap, fastened using fasteners such as a clip, or hook-and-eye, or hook-and-loop. Another variation that can be made to the sleeve on BTE models is to close the bottom either by sewing it shut, or by adhesive, or again by applying a fastened flap. Some FM users may want the extra security provided by the closed bottom. For the ITE model the sleeve will be considerably shorter and come in various sizes to accommodate a range of ITE models. The ITE sleeve maybe open at the top or closed at the top and open at the bottom to accommodate the insertion of the ITE into the ear.

There are also several variations that can be made to the protective device cord. The cord can be shortened or lengthened to accommodate infant, children and adult users. The cord can also adjusted to accommodate mono models.

In summary, the present invention may be characterized as a security and protection device for an ear-mounted audio amplifier or telecommunication instrument wherein the device includes a resilient water-pervious hollow sleeve sized and shaped to snugly conform to the shape of an audio amplifier or telecommunication instrument having an earpiece insertable in to the ear of a user when the sleeve is slid over the instrument. The sleeve provides protection to the instrument and soft resilient comfort to a wearer. The sleeve has a top opening at a top end of the sleeve and a bottom opening at an opposite bottom end of the sleeve. The bottom opening is sized to snugly receive the instrument into the hollow sleeve so as to substantially completely cover the instrument when journalled in the sleeve. The top opening is sized to snugly receive through the top opening a corresponding upper end of the instrument. The upper end of the instrument is connected to the instrument earpiece.

The sleeve has a longitudinal axis and is elongate along said longitudinal axis. The bottom opening lies in a plane which is substantially orthogonal to the longitudinal axis. The top opening lies substantially in a plane which is substantially parallel to the longitudinal axis and laterally offset therefrom, so as to beg in a side wall of the sleeve. Advantageously the sleeve is made of a light woven, breathable resilient moisture-wicking fabric, for example chosen from the group comprising: neoprene, Spandex, cotton, wool.

The device may further include a length of resilient cord mounted at a first end thereof to the sleeve, and at an opposite end thereof to a releasable fastener. The sleeve may be a pair of sleeves mounted at opposite ends of the cord, in which case the fastener may be midway along the cord. The fastener may be a clip.

An aperture may be formed in a back surface of the sleeve corresponding to controls on the instrument when the instrument is journalled in the sleeve. The top and bottom openings may each include a releasably fastenable closure.

In one embodiment the instrument is a wireless headset for communicating with a wireless telecommunication device, wherein the headset includes a microphone positioned on the headset so as to be adjacent the cheek of the user when the earpiece of the headset is mounted in the user's ear. In that embodiment the sleeve covers the microphone of the headset when the headset is mounted in the sleeve with the earpiece protruding from the top opening.

### BRIEF DESCRIPTION OF THE DRAWINGS

FIG. 1 shows, in side elevation, the head of a woman wearing a hearing aid within a sleeve according to one embodiment of the present invention.

FIG. 2 is a frontal view of a pair of sleeves mounted at the opposite ends of a length of resilient cord, where each sleeve has an opening at its opposite ends.

FIG. 3 is, in perspective view, one of the sleeves of FIG. 2 shown expanded and slid over a hearing aid.

FIG. 4a is, in top perspective view, one of the sleeves of FIG. 2.

FIG. 4b is, in bottom perspective view, one of the sleeves of FIG. 2.

FIG. 5a is, in side elevation view, one of the sleeves of FIG. 2 with the cord removed.

FIG. 5b is the view of FIG. 5a with the sleeve lengthened to accommodate a longer hearing aid.

FIG. 5c is a sleeve according to FIG. 5a with the length shortened to accommodate a shorter hearing aid.

FIG. 12b is, in side elevation view, a sleeve such as found in FIG. 2, with the bottom of the sleeve closed.

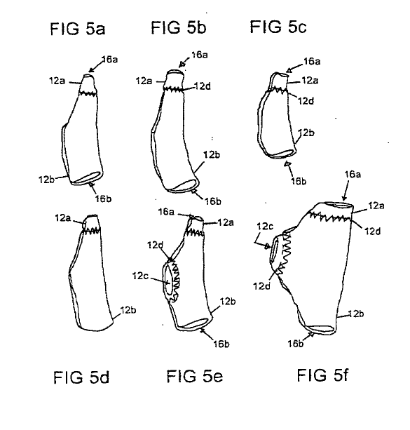

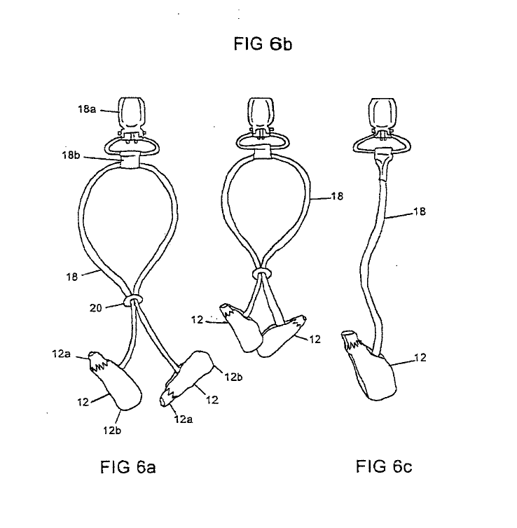

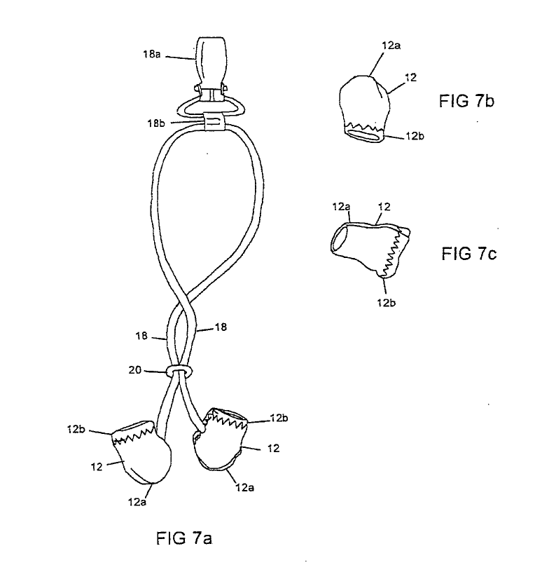

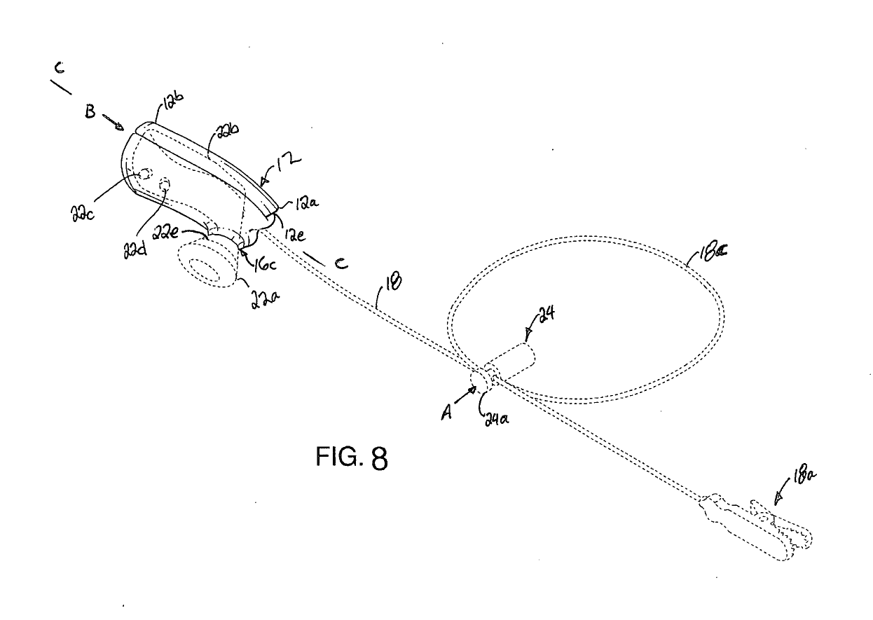

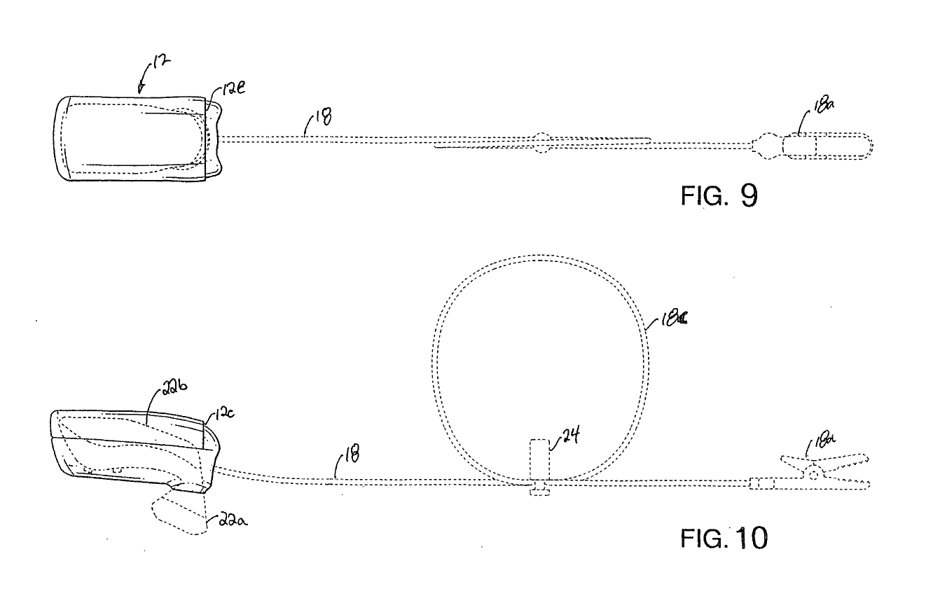

FIG. 5e is a sleeve according to a further embodiment further including a third opening on the back of the sleeve.

FIG. 5f is, in side elevation view, an enlarged sleeve having top and bottom openings and a third opening on the back surface thereof.

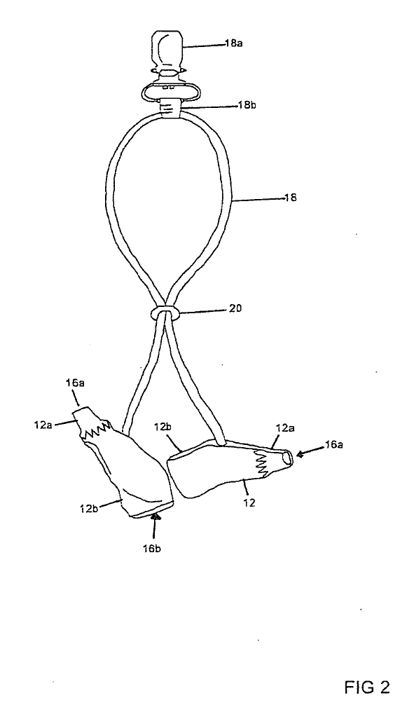

FIG. 6a is the view substantially of FIG. 2 juxtaposed along side the view of FIG. 6b.

FIG. 6b is a view in juxtaposed along side FIG. 6a to show an embodiment having a shorter cord.

FIG. 6c illustrates an embodiment having a single sleeve attached to one end of a single length of cord, a clip mounted to the opposite end of the cord.

FIG. 7a is, in front view, a further embodiment of the device of FIG. 2.

FIG. 7b is, in perspective view, one of the sleeves from FIG. 7a.

FIG. 7b is, in perspective view, a further embodiment of one of the sleeves from FIG. 7a.

FIG. 8 is, in perspective view, a further embodiment of the protective device according to one aspect of the present invention, mounted onto a Bluetooth™ Jawbone™ headset (shown in dotted outline), and having a resilient cord and mounting clip at the opposite end of the cord mounted to one end of the sleeve.

FIG. 9 is, in plan view, the view of FIG. 8.

FIG. 10 is, in right side elevation view, the view of FIG. 8.

FIG. 11 is, in left side elevation view, the view of FIG. 8.

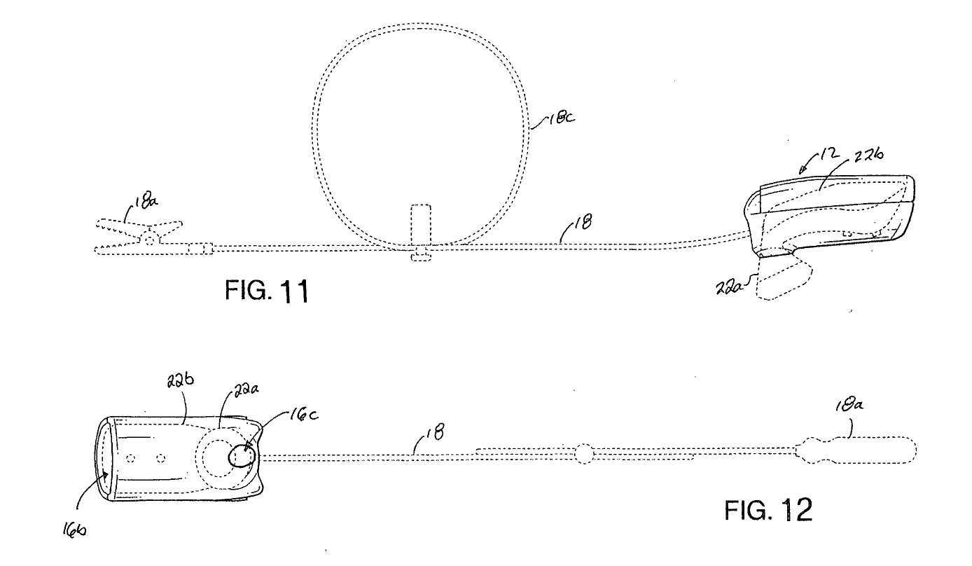

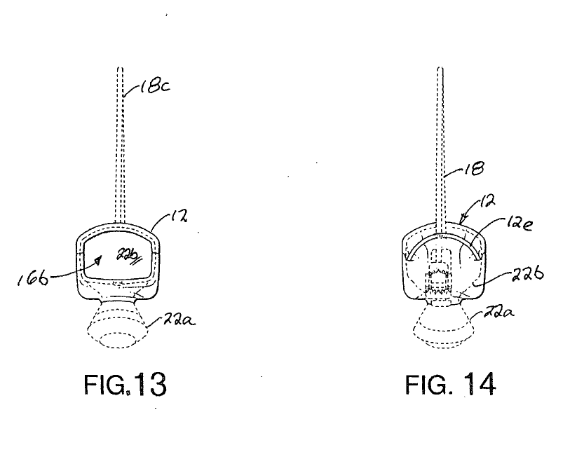

FIG. 12 is, in bottom view, the view of FIG. 8.

FIG. 13 is, in one end elevation view, the view of FIG. 8.

FIG. 14 is, in the opposite end view, the view of FIG. 8.

### DETAILED DESCRIPTION OF EMBODIMENTS OF THE INVENTION

To install a hearing aid such a BTE into protective device sleeve 12, the earmold 14a is removed from the BTE, and then the top end of the BTE is slid upwardly into the larger hole 16b at the bottom end 12b of the protective device sleeve 12. The top end or hook part of the BTE comes out of the smaller hole 16a at the top end 12a of the sleeve. The earmold 14a is then reattached to the BTE hook. For the ITE model, the Protective device sleeve is modified, and slips over the top of the ITE, leaving the inner mold exposed. There are currently eight embodiments of Protective devices, as follows:
1. Original Binaural & Mono, Original cordless
2. FM Binaural & Mono, FM cordless
3. Infant Binaural & Mono, Infant Binaural & Mono FM
4. Cochlear, Cochlear cordless
5. Mini, Mini cordless
6. ITE Binaural & Mono, ITE cordless
7. Open back
8. Bottom closed sleeve

The Original Binaural has a cord 18 which is approximately 16 inches long. Either end of the cord attaches to a left and right sleeve. The centre of the cord is attached to a clip 18a which in turn attaches to clothing (not shown) such as a shirt, jacket, or sweater. The cord 18 also has a plastic cinching ring 20 that allows the user to adjust the cord length and limits the bi-lateral movement of the hearing aid instruments. As seen in FIG. 6c, the original Mono embodiment has a single cord, approx. 8 inches long, that attaches to a single sleeve. The cord is attached at one end to the sleeve and at the other end to the clip which in turn is attached to clothing.

In a first embodiment the sleeve 12 is approximately one and ¾ inches long (to fit most BTE's 14). Sleeve 12 has an approximately ¼ inch diameter top opening 16a at the top 12a of the sleeve 12 and a slightly wider diameter opening 16b at the bottom 12b of sleeve 12, for example approximately ⅝ inch. The width of sleeve 12 at the middle when laid flat is approximately ¾ inch. A sleeve 12 is mounted at each opposite end of the cord 18.

As stated above, other variations of the Protective device include Cordless, Binaural and Mono Open Back, Binaural and Mono Closed Bottom. Each different embodiment accommodates different hearing aid models and the different needs of hearing aid users. The FM Binaural, like the first embodiment, also has a cord 18 which is approximately 16 inches long, and the cord has a clip 18a mounted mid-way along its length. However, the FM sleeve 12 is longer, approximately two and ¾ inch, to adjust for the attachment of an FM unit at the bottom of a BTE. The FM Mono embodiment; like the Mono embodiment, has a shorter cord 18, approximately 8 inches long, that is attached to a single sleeve 12. Other variations to the FM embodiment include FM Cordless, FM Binaural and Mono Open Back, and the FM Binaural and Mono Closed Bottom embodiments. The Infant Binaural embodiment is a variation of the first embodiment, where the cord length is shorter, being approximately 12 inches long. A left and a right sleeve 12 attaches to either end of the 12 inch lengthen of cord 18. Again, plastic cinching ring 20 allows the user to adjust the cord length and limits the bi-lateral movement of the hearing aid instruments.

In the mono-aural embodiment a single sleeve 12 is employed on a single cord which is half the length of cord 18. For an infant using a mono aural embodiment, cord 18 may be approximately 6 inches long. The sleeve 12 for infant BTE and the adult size sleeve 12 are approximately the same size and fit a one and ¾″ (approx. length) BTE.

The infant FM Binaural embodiment is a variation of the FM embodiment. The protective device Infant FM embodiment has a cord 18 which is approximately 12 inches long. A left sleeve 12 and a right sleeve 12 are attached to opposite ends of the cord 18. In the Infant FM Mono embodiment a shorter cord 18, approximately 6 inches long, attaches to a single sleeve 12. Like the FM embodiment, sleeve 12 of the Infant FM Binaural and mono-aural embodiments is longer, being approximately two and ¾″, to adjust for the attachment of an FM unit at the bottom of the BTE. Some hearing aid users do not need or want the security provided by the cord 18 and attaching clip 18a in which case only sleeves 12 are required.

The embodiment having a back opening 12c is provided for use with BTE's having volume controls located at the back of the hearing aid instrument 14. Back opening 12c may be closed with a flap, or with a releasable fastener (not shown), such as a hook-and-loop strip, or a hook and eye mounted in the opening.

The embodiment having a closed bottom is provided because some hearing aid users want to ensure that their hearing aid is enclosed. This is particularly important for FM hearing aid Instruments, that may include a boot that attaches to the bottom of the instrument, and so consequently the users want to ensure that the FM boot does not slip off the instrument and fall through the opening 16b in the bottom end 12b of the sleeve. The bottom end 12b may be closed either by being sewn closed or closed with a fastener (not shown) such as a hook-and-loop strip or hook and eye. All embodiments may be adapted to include an opening 12c and/or to have a closed bottom 12b. The Cochlear embodiment has a wider sleeve to accommodate the larger Cochlear processor. The Cochlear embodiment has an approximately ⅝ inch opening at the top 12a and is approximately one and ¼ inches wide at the centre. The Cochlear embodiments all have an opening 12c to accommodate a short wire cord that attaches the BTE processor to the actual Cochlear hearing aid instrument.

Some Cochlear BTE users use a standard BTE on one ear and a Cochlear processor on the other ear. The correct sized sleeve 12 is chosen depending on the hearing aid being used. A Mini Binaural embodiment has a cord 18 which is approximately 16 inches long. A Mini Mono-aural embodiment uses a shorter cord, approximately 8 inches long, which is attached to only a single sleeve. So-called “Open Fit” BTE's are less than one and ¾ inches long. Again, sleeve 12 is sized accordingly.

The ITE embodiment accommodates hearing aids worn in the user's ear. There are various sizes of ITE and consequently the ITE embodiment is provided in various corresponding sizes. The ITE sleeve 12 is only different in that it is shorter. The sleeve 12 for an ITE may range from approximately ¾ inches to one and ¼ inches in length. One such sleeve is closed at the top end 12a and open at the bottom end 12b. Another has a sleeve 12 that is open on both ends. Cord 18 for such sleeves are approximately 16″ long.

The present invention provides improved security and comfort, as it both wicks away moisture from the user's ear and prevents chaffing, and helps protect the hearing aid batteries which may become damaged when exposed to excessive moisture. Users may find the sleeve 12 more attractive to wear than an exposed hearing aid 14.

As stated above, sleeve 12 is provided in the same shape as a BTE hearing aid to provide protection for the hearing aid and soft resilient comfort for the user's ear. The sleeve has a small opening 16a at the top end, 12a which maybe approximately ¼ inch in diameter for securely fitting over the hearing aid top end or hook and onto the body of the hearing aid. There is a larger approximately ⅝ inch opening 16b on the bottom end 12b that provides access to the battery compartment. The sleeve may range from one inch or less in length in the mini embodiment to two and ¾ inches in the FM embodiment, or longer. A typical sleeve 12 may be approximately one and ¾ inches long. Each sleeve 12 may be made of a light woven, breathable fabric. Sleeves 12 can be made from a wide range of fabrics including neoprene, Spandex, cotton, and wool. The sleeve may range from one inch or less in length and accommodate an “Open Fit” BTE.

The ITE embodiment sleeve covers the outer exposed area of the ITE hearing aid and leaves the earmold uncovered. The bottom of the ITE embodiment sleeve is approximately ¼ inch long and reinforced with stitching 12d. Again, sleeves 12 can be made from a wide range of fabrics including but not limited to neoprene, Spandex or a jersey cotton knit. Attached to the centre of the back of each sleeve 12 is a length of resilient cord 18 that will typically range from approximately 16 to 12 inches in length and be either sewn to the sleeve or woven from the back in one continuous piece. The left sleeve 12 and right sleeve 12 will both be attached to either end of the cord. Clip 18a is attached by fastener 18b at the centre of the cord. The cord may be of equal length on either side of clip 18a. Other fastening devices other than clip 18a or the metal cylinder 18b of FIG. 7a may be used. Opening 12c may be reinforced with stitching 12d and allows access to hearing aid controls.

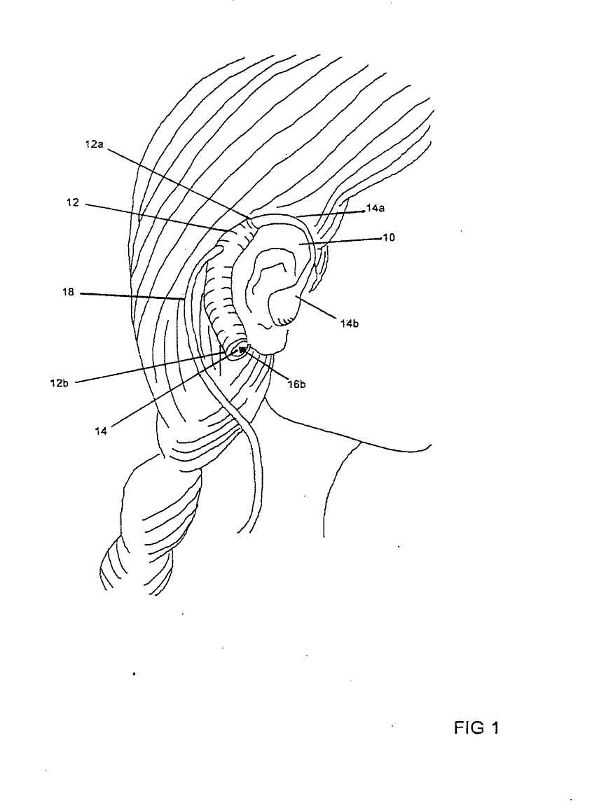

FIG. 1 illustrates a BTE-style battery operated hearing aid 14 (a “BTE”) worn behind the ear 10 of a user. The BTE 14 is enclosed inside of resilient sleeve 12. As seen in FIG. 2 elastic cord 18 has one end attached to one sleeve 12 the opposite end attached to another sleeve 12. Clip 18a is attached mid way along the length of cord 18. A cinching ring 20 may be provided to cinch the loop of cord 18 up behind the nape of the neck of the user to reduce lateral movement of the cord during use.

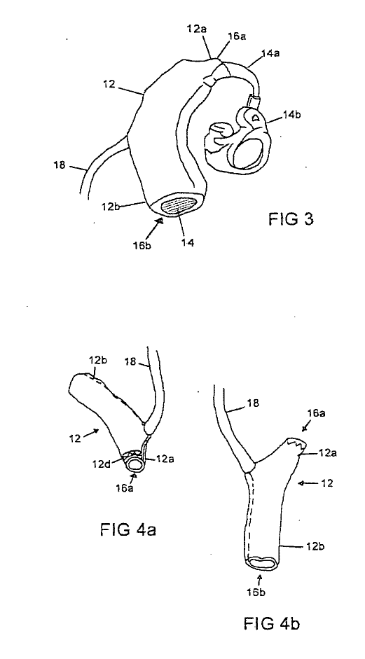

A BTE style hearing aid is better seen in FIG. 3, enclosed in a sleeve 12 with the elastic cord 18 leading from the BTE, it being understood that the other end of the cord is attached to the other sleeve 12. The hook 14a of the BTE 14 is visible, extending from the body of the BTE inside the sleeve. An ear mold 14b is mounted on the end of hook 14a. The sleeve 12 expands to fit over the BTE. FIGS. 4a and 4b show sleeve 12 in a perspective view from top and bottom respectively, before being fitted over a BTE. In this embodiment the smaller opening 16a at the top 12a is ¼″ inch while the larger opening 16b at the bottom 12b is ⅝ of an inch. The sleeve 12 expands as it is slid over the body of the hearing aid, thereby providing a snug, secure fit.

FIG. 5a illustrates a typical sleeve 12 which is one and ¾ inches long. FIG. 5b illustrates the sleeve of the FM embodiment at two and ¾ inches long. FIG. 5c illustrates the sleeve of the mini embodiment at 1 inch long. FIG. 5d illustrates the sleeve of FIG. 5a with a closed bottom end 12b. FIG. 5e illustrates the sleeve of FIG. 5a with an opening 12c on its back to improve access by a user to volume controls on the BTE. FIG. 5f illustrates the Cochlear embodiment of sleeve 12, at two and ½ inches long. It is wider than the sleeve of FIG. 5a and has an opening 12c at the back to accommodate the wire cord that connects the Cochlear processor to the Cochlear hearing aid instrument.

FIG. 6a illustrates a pair of sleeves 12 mounted on the opposite ends of a length of cord 18. Again, clip 18a is mounted to cord 18 midway along the length of the cord. In this embodiment cord 18 is approximately 8″ long on each side of clip 18a. FIG. 6b illustrates the shorter cord 18 of the Infant embodiment. The cord 18 is approximately 6″ long on each side of clip 18a. FIG. 6c illustrates mono-aural embodiment. The cord is attached at one end to a single sleeve 12 and at the other end to clip 18a. In FIGS. 6a and 6b cord 18 is one continuous length that slips through a metal cylinder fastener 18b that is attached to the clip 18a. In FIG. 6c the cord is attached to the clip by crimping a piece of metal to the end of the cord and to the clip.

FIG. 7a illustrates the ITE embodiment. As seen in FIGS. 6a and 6b a cinching ring 20 reduces lateral movement when cinched towards sleeves 12. The ITE sleeve 12 of FIG. 7a is smaller to fit ITE hearing aid instruments. Again, cord 18 is attached to the sleeve 12 and clip 18a. The ITE sleeve 12 is the same shape as an ITE hearing aid instrument. The ITE hearing aid is both a hearing instrument and ear mold in one piece. The ITE sleeve is closed at the top 12a and open on the bottom 12b to accommodate the ITE mold. FIG. 7b further illustrates the ITE embodiment sleeve of FIG. 7a. FIG. 7c illustrates an ITE embodiment where the top end 12a is open to accommodate smaller ITE hearing instruments and the bottom end 12b is open to accommodate the ITE mold.

In the embodiment of FIGS. 8-14, sleeve 12 is adapted to snugly fit over a telecommunication headset 22 (shown in dotted outline) which may for example be a telecommunication headset such as sold under the trademark Jawbone™ for wireless communication between headset 22 and for example a wireless telephone such as a cellular telephone. Headset 22 as illustrated, mounts into ear 10 by the snug insertion of a resilient earpiece 22a. A hard body or housing 22b which contains the processor, transceiver, microphone, etc is mounted to earpiece 22a so that earpiece 22a extends substantially at right angles from the upper end of body 22b. As before, the upper end 12a of sleeve 12 corresponds to the upper end of the insert within the sleeve, that is the upper end of body 22b. Again as before, the upper end of the insert, in this case the upper end of body 22b and earpiece 22a are inserted into sleeve 12 through the opening 16b in the lower end of 12b of sleeve 12. Cord 18 is mounted at one end to the upper end 12a of sleeve 12, for example, and without intending to be limiting, by being sewn into the stitched seam 12e used to close the upper end 12a of sleeve 12. Clip 18a is mounted at opposite end of cord 18. Instead of the use of a cinching ring 20, a resiliently biased clamp 24 may be mounted along cord 18 so as to resiliently pinch, for example by the operation of a spring (not shown) housed within clamp 24 acting to resiliently bias plunger 24a in direction A, so as to thereby pinch or clamp both ends of the loop 18a formed for example substantially mid way along the length of cord 18. As before, clip 18c is used to clip the distal end of cord 18, distal from sleeve 12, to the clothing of the user.

As before, sleeve 12 may be advantageously made of a light, resilient breathable fabric, which may be for example a woven fabric, and may for example be made of Spandex, neoprene, cotton, wool, etc. Thus for example for use with a Jawbone™, Bluetooth™, wireless headset for wireless communication between the headset and a cellular telephone, applicant has determined that Spandex fabric will not interfere with the operation of the Jawbone which requires the user to compress the housing or buttons on the housing of the head set, and does not substantially interfere with the clarity of audio amplification (as sleeve 12 does not cover over earpiece 22a), and does not noticeably interfere with or otherwise appear to attenuate the reception of the telecommunication transmission being received and transmitted by headset 22. Thus with respect to the Jawbone™ headset in particular, the recommended usage of the Jawbone™ headset recommends that the rubber nub 22c which is mounted to so as to extend from the bottom end of body 22b, protruding on the same side from body 22b as earpiece 22a and power switch 22d, in operation rests against the user's cheek. Applicant has determined that the interleaving of the fabric of sleeve 12 between nub 22c and the cheek of the user does not interfere with the telecommunication operation of the headset.

Although only the Jawbone™ style headset 22 is illustrated, it is understood that sleeve 12 may be adapted to snugly fit over other wireless headsets for example other wireless Bluetooth™ headsets for use in association with cellular telephones and the like without departing from the scope of the present invention. Also, for headsets of the style which, in the manner of hearing aid BTE embodiments, which mount behind the ear of the user, it is further understood that, sleeve 12 may also be adapted to snugly fit over such behind-the-ear telecommunication headsets 22. However, again, with respect to the illustrated Jawbone™ headset 22, which has an internal microphone (not separately visible) which one might expect the fabric of sleeve 12 to interfere with as sleeve 12 covers over the microphone, again applicant has determined that sleeve 12 is substantially acoustically transparent to the passing of audio from the user to the microphone. Consequently, sleeve 12 has only the minimum necessary number of apertures, namely opening 16b at the bottom end 12b, and earpiece opening 16c at the top end 12a through which earpiece 22a protrudes, to thereby, to the extent possible, protect headset 22 from dust, moisture either incursion or retention, and also to provide a light impact protection to the headset.

When installing headset 22 into sleeve 12, the headset is inserted, earpiece 22a first, in direction B along the longitudinal axis C of the sleeve 12 until the earpiece can be popped through the resilient circumference of the rim of top opening or earpiece opening 16c. As the earpiece passes through opening 16c, the body 22b of the headset seats snugly into sleeve 12 so as to completely occupy the available volume within the sleeve, and advantageously so as to slightly resiliently expand sleeve 12 thereby ensuring a snug fit and good retention of the sleeve on the headset. Once the earpiece has passed through opening 16c, the resilient circumference or rim around opening 16c closes snugly around the narrow stalk 22e of the earpiece to snugly seal around the stalk.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A security and protection device for an ear-mounted audio amplifier or telecommunication instrument, the device comprising a resilient water-pervious hollow sleeve sized and shaped to snugly conform to the shape of an audio amplifier or telecommunication instrument having an earpiece insertable in to the ear of a user when said sleeve is slid over the instrument, whereby said sleeve provides protection to the instrument and soft resilient comfort to a wearer, and wherein said sleeve has a top opening at a top end of said sleeve and a bottom opening at an opposite bottom end of said sleeve, and wherein said bottom opening is sized to snugly receive the instrument into said hollow sleeve so as to substantially completely cover said instrument when journalled in said sleeve, and wherein said top opening is sized to snugly receive through said top opening a corresponding upper end of said instrument wherein the upper end of the instrument is connected to the instrument earpiece.

2. The device of claim 1 wherein said sleeve has a longitudinal axis and is elongate along said longitudinal axis, and wherein said bottom opening lies in a plane which is substantially orthogonal to said longitudinal axis and wherein said top opening lies substantially in a plane which is substantially parallel to said longitudinal axis and laterally offset therefrom, said top opening being in a side wall of said sleeve.

3. The device of claim 2 wherein said sleeve is made of a light woven, breathable resilient moisture-wicking fabric.

4. The device of claim 3 wherein said fabric is chosen from the group comprising:
neoprene, Spandex, cotton, wool.

5. The device of claim 1 further comprising a length of resilient cord mounted at a first end thereof to said sleeve, and at an opposite end thereof to a releasable fastener.

6. The device of claim 5 wherein said sleeve is a pair of sleeves, said pair of sleeves mounted at opposite ends of said cord.

7. The device of claim 6 wherein said fastener is midway along said cord.

8. The device of claim 7 wherein said fastener is a clip.

9. The device of claim 1 further comprising an aperture in said sleeve on a back surface of said sleeve corresponding to controls on the instrument when said instrument is journalled in said sleeve.

10. The device of claim 1 wherein either of said top and bottom openings includes a releasably fastenable closure.

11. The device of claim 4 wherein said instrument is a wireless headset for communicating with a wireless telecommunication device, wherein said headset includes a microphone positioned on the headset so as to be adjacent the cheek of the user when the earpiece of the headset is mounted in the user's ear, and wherein said sleeve covers the microphone of the headset when the headset is mounted in the sleeve with the earpiece protruding from the top opening.
